(19) United States
(12) Patent Application Publication
(10) Pub. No.: US 2006/0265232 A1
(43) Pub. Date: Nov. 23, 2006

(54) Adaptive customer assistance system for software products

(75) Inventors: Sanjeev Katariya, Bellevue, WA (US); Hsiao-Wuen Hon, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/133,549

(22) Filed: May 20, 2005

(51) Int. Cl. G06Q 99/00

(52) U.S. Cl. 705/1

(57) ABSTRACT

An adaptive customer assistance system that can serve as an integrated online and offline help platform for a suite of software products is provided. The assistance system includes a customer-interaction interface and a data management component and a download management component for distributed customer interaction. The data management component includes an authoring component, a download component, a runtime component and an analysis component. The runtime component, which includes a customer assistance model, is configured to receive a user-formulated question from the customer-interaction interface. The runtime component provides an answer to the user-formulated question based on information included in the customer assistance model. The analysis component automatically analyzes, in substantially real-time, the user-formulated question and the corresponding answer, and provides an analysis output for use in improving a quality of customer assistance.

### BACKGROUND OF THE INVENTION

The present invention generally relates to help facilities for software products. More particularly, the present invention relates to an adaptive customer assistance system for software products.

Most software products/applications are designed to include some type of help or customer assistance facility. These help facilities are usually designed integrally within the software application and, in general, explain various components of the software application. Early help systems were only capable of displaying the same information (or static information), regardless of the context or circumstances surrounding the request for help. More recent help systems provide context-sensitive help, which provides the users with the specific help topic for the context to which it relates. For example, in a word processing application, if the user is editing a document and selects a command such as “FILE” from the drop-down menu and further presses a function key such as “F1” for HELP, a context-sensitive facility opens a window explaining the functions offered under the drop-down menu.

The above described help facilities clearly have several advantages over searching through printed documentation for help, which may be disruptive and very time consuming. Further, the context-specific help is relatively easy to use and provides information that is focused on a desired context. However, as mentioned above, these help facilities are usually designed within the software application and therefore may be inconsistent in appearance and content across multiple versions of the software application and may also be inconsistent across multiple applications of a software suite, for example. Further, although some software applications allow a user to query the help facility by using words, phrases and terminology of the user's natural language, such systems have typically been unable to successfully answer a sufficient number of questions to make them useful. Additionally, such systems do not include “learning” or self-tuning functions that allow the help system to automatically improve its quality of assistance.

### SUMMARY OF THE INVENTION

An adaptive customer assistance system that can serve as an integrated online and offline help platform for a suite of software products is provided. The assistance system includes a customer-interaction interface and a data management component and a download management component for distributed customer interaction. The data management component includes an authoring component, a download component, a runtime component and an analysis component. The runtime component, which includes a customer assistance model, is configured to receive a user-formulated question from the customer-interaction interface. The runtime component provides an answer to the user-formulated question based on information included in the customer assistance model. The analysis component automatically analyzes, in substantially real-time, the user-formulated question and the corresponding answer, and provides an analysis output for use in improving a quality of customer assistance.

### BRIEF DESCRIPTION OF THE DRAWINGS

FIG. 1 is a block diagram of one illustrative computing environment in which the present invention can be implemented.

FIG. 2 is a block diagram of a software system that utilizes an adaptive customer assistance system of the present invention.

FIG. 3 is a block diagram illustrating components of an embodiment of adaptive customer assistance system of the present invention.

FIG. 4 is a block diagram illustrating sub-components of a runtime component of the adaptive customer assistance system of FIG. 3.

FIG. 5 is a block diagram illustrating sub-components of an analysis component of the adaptive customer assistance system of FIG. 3.

FIG. 6 is a block diagram illustrating sub-components of a publishing component of the adaptive customer assistance system of FIG. 3.

### DETAILED DESCRIPTION OF ILLUSTRATIVE EMBODIMENTS

The present invention relates, in general, to a customer assistance system for use with different software products. More specifically, the present invention provides a customer assistance system which is self-monitoring and adaptive (uses closed-loop action to optimize its performance) and can serve as a uniform or common help platform for different software products. However, before describing the present invention in greater detail, one illustrative embodiment in which the present invention can be used will be discussed.

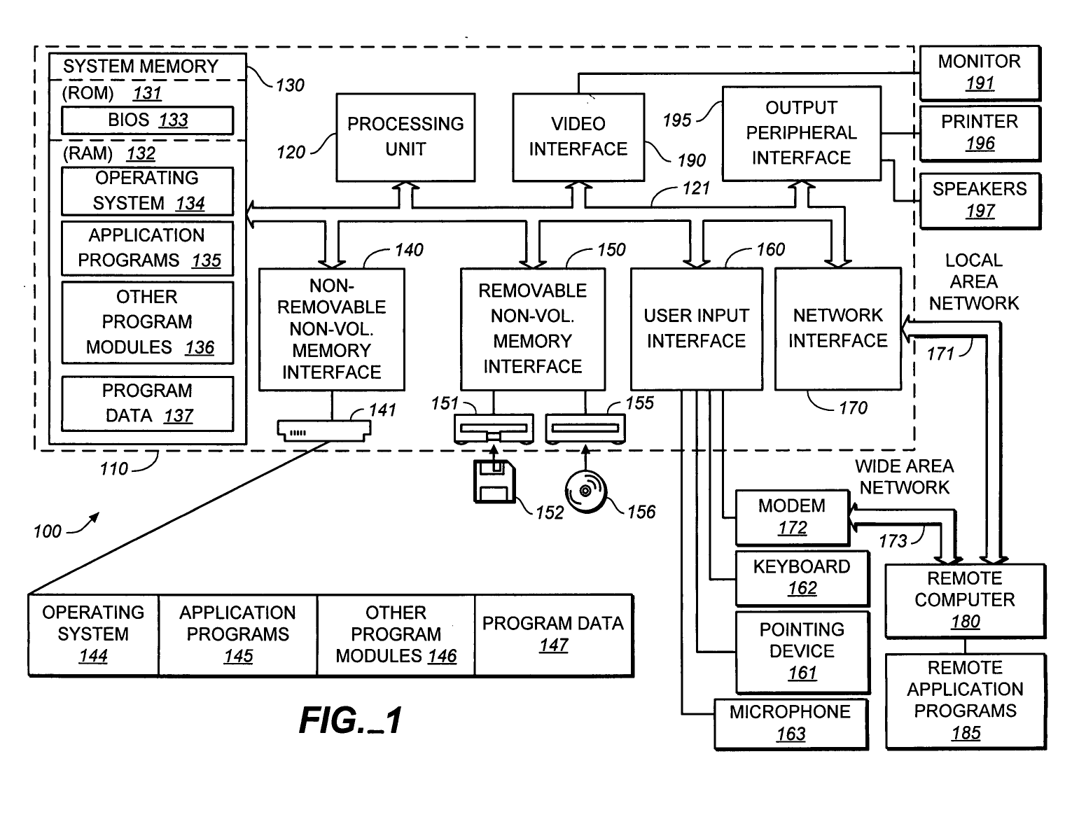

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

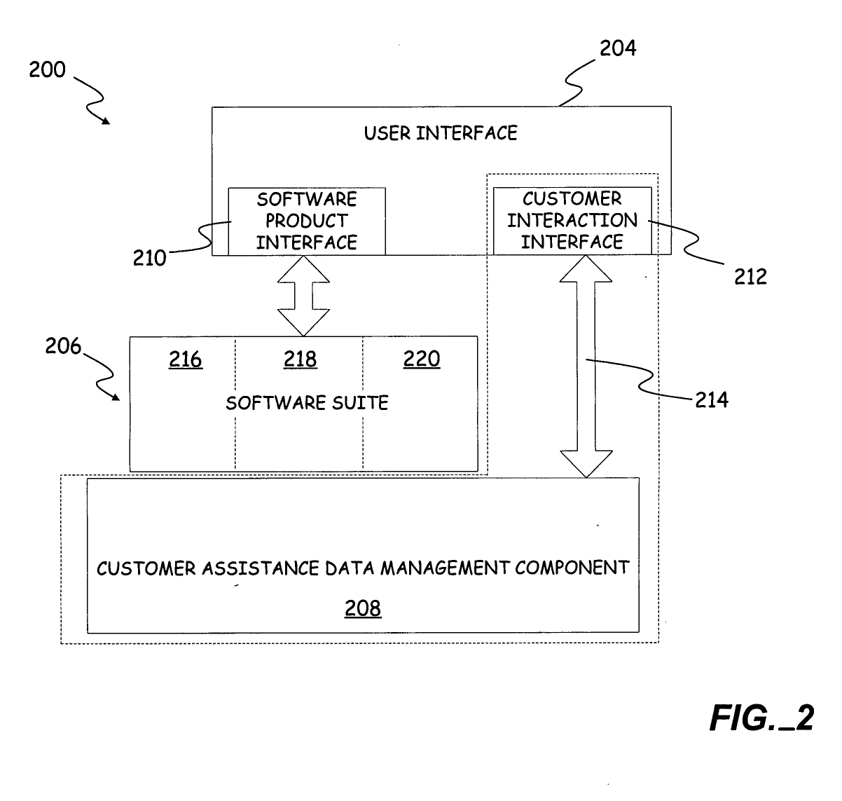

FIG. 2 is a simplified block diagram of a software system 200 that includes an adaptive customer assistance system 202 of the present invention. Software system 200 includes a user interface 204, a software suite (a collection of software products, usually applications of related functionality, often sharing a more-or-less common user interface and some ability to exchange data with each other smoothly) 206, and a customer assistance data management component 208.

User interface 204 includes a software product interface component 210 and a customer assistance interface component 212. For simplification, FIG. 2 shows a single separate communication path 214 from customer assistance interface component 212 to customer assistance data management component 208. However, customer assistance data management component 208 is typically accessible from different entry points or communication paths within components/products 216, 218 and 220 of software suite 206.

As can be seen in FIG. 2, customer assistance interface component 212 and customer assistance data management component 208 together form customer assistance system 202. In the embodiment shown in FIG. 2, customer assistance system 202 serves as a common customer assistance platform on which components/products 216, 218 and 220 of software suit 206 can run. Such a common customer assistance platform helps ensure that users experience consistent assistance across components/products 216, 218 and 220 of software suite 206.

Customer assistance system components 208 and 212 (or sub-components of these components) may reside on different parts of a distributed computing system. For example, in a client-server environment, sub-components of component 212, which are accessed by a customer, reside on a client and sub-components of component 208 that store customer assistance data can reside on a server.

In such a computing environment, a user types in a question (related to a certain application/component 216, 218, 220 of suite 206, for example), and submits the question, via a client user interface (sub-component of component 212). A server (which includes at least some sub-components of component 208) receives the question and provides a list of responses, which may be ranked, for example. The user receives these responses on the client user interface and typically clicks on (or selects) one or more of the responses to view details for a particular response, for example. The user may also rank (or re-rank) the responses. Components of system 202, which are described further below, can monitor the questions entered by the user, the response(s) provided by system 202 to the questions, the particular response(s) that the user selects from a ranked response list, rankings that a user assigns to a response, etc. System 202 aggregates the feedback obtained by monitoring the above activities and uses the aggregated feedback to improve, in substantially real-time, the relevance of responses and general quality of assistance that it provides to a user. Thus, customer assistance system 202 is an adaptive self-monitoring system.

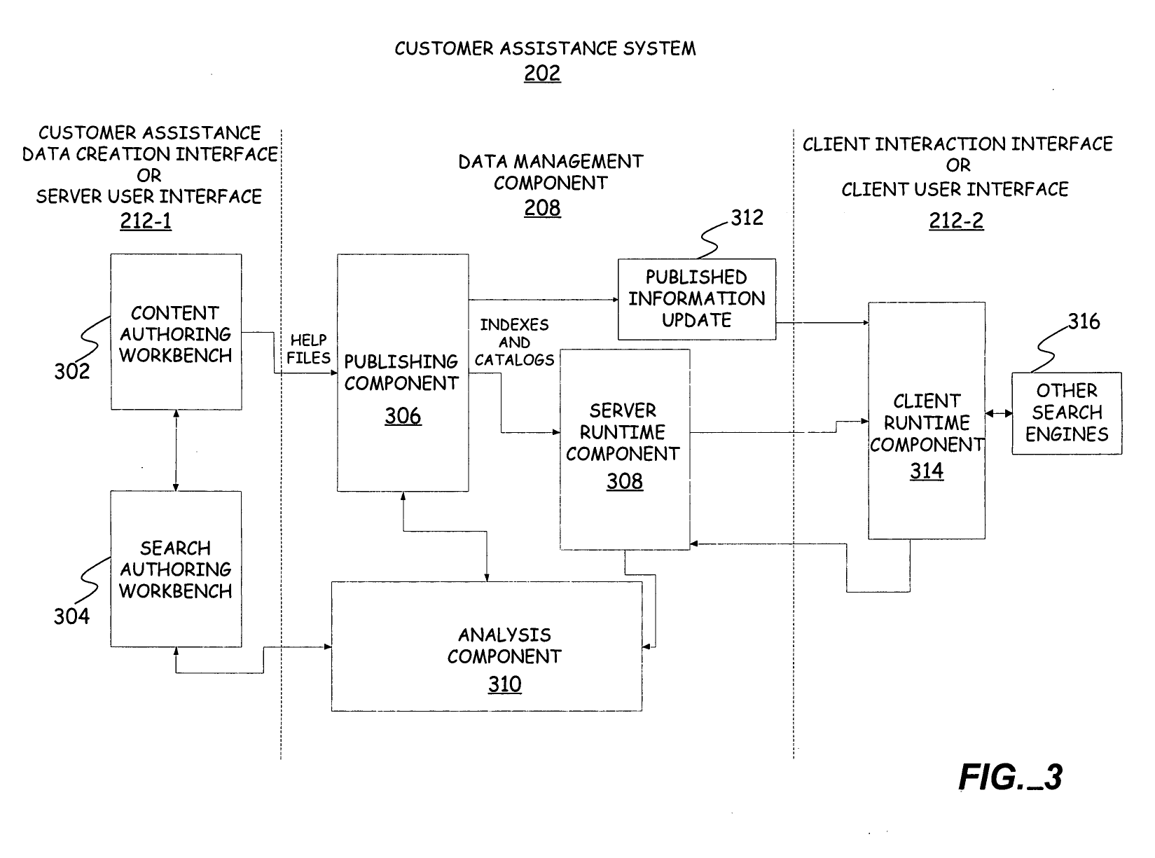

It should be noted that customer assistance data (or help content) can be created using authoring tools, included in system 202, which are accessible from a server user interface described further below. Also, quality metrics are typically predefined in system 202 to help quantify the “quality of assistance” provided and thereafter the “improvement gained” with feedback. The adaptive self-monitoring nature of system 202 will be more evident from the following description of detailed embodiments of the present invention provided in connection with FIGS. 3 through 6.

FIG. 3 is a simplified block diagram illustrating components of an embodiment of adaptive customer assistance system 202 of the present invention. From the description provided earlier, it is clear that customer assistance system 202 is largely data centric (or data driven) and essentially “manages” data and “presents” data. The general separation of data management functions/components from data presentation functions/components (depicted with the help of dashed lined in FIG. 3) helps emphasize the data driven nature of system 202, and its components and sub-components, emphasizing the boundaries and actions performed on data as it progresses through system 202.

In FIG. 3, the data presentation components include a customer assistance data creation interface 212-1 (user interface for creating customer assistance data using authoring tools) and a customer interaction interface 212-2 (presentation in the case of customer interaction). Shown between presentation components 212-1 and 212-2 is data management component 208 where, once created, the customer assistance data (or content) is published, aggregated, transformed, delivered, gathered and analyzed.

In essence, customer assistance system 202 (shown in FIG. 3) provides a substantially complete user assistance platform that has authoring tools that are employed to create the help content, publishing systems that help publish it, runtime systems that a user interacts with to get search results from the published information, and feedback systems that aggregate feedback on how well the system is providing assistance. Any questions that result in holes (gaps in content which result in a user receiving no information in response to a particular question) are identified by system 202 and are automatically communicated to the authoring environment to be filled by an author. The addressing/filling of holes is thus a semi-automatic process. However, as will be apparent form a description of the sub-components of system 202 provided below, improvements in responses to questions, in general, occur automatically in system 202.

As mentioned above, the primary components of system 202 of FIG. 3 are customer assistance data creation interface 212-1, customer interaction interface 212-2 and data management component 208. Customer assistance data creation interface (or server user interface in a client server environment) 212-1 includes a content authoring workbench 302 and a search authoring workbench 304. Content authoring workbench 302 includes authoring tools that content authors can use to create help documents or files that are used to form an information repository for system 202. An example authoring tool that can be used to create the help documents is Microsoft® DOCStudio. Of course, others could be used as well. The help documents that are output from content authoring workbench 302 can be Extensible Mark-up Language (XML) files with corresponding metadata that includes document identification information, for example. Search authoring workbench 304 includes tools/modules that receive feedback from data management component 208, regarding relevance of answers provided, and provide aggregated relevance-related feedback to content authoring workbench 302. Content authoring workbench 302 can utilize this aggregated relevance-related feedback to direct authors to improve content in the help files.

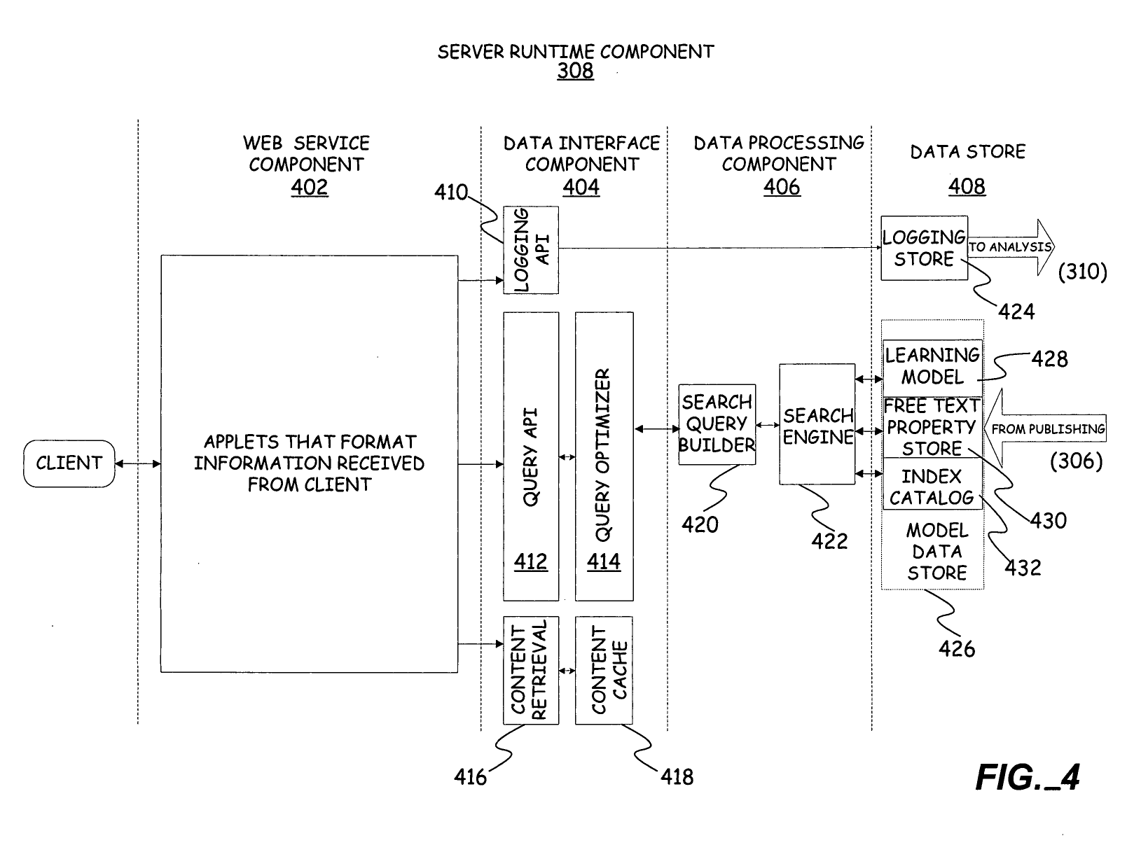

Data management component 208 includes a publishing component 306, a runtime component (or server runtime component in a client-server environment) 308 and an analysis component 310. A brief description of the functions of each of these components is provided below and a more detailed description of the sub-parts of components 306, 308 and 310 is provided further below in connection with FIGS. 4 through 6.

As can be seen in FIG. 3, publishing component 306 receives help files that are output from content authoring workbench 302. In general, publishing component 306 can receive help files from any source. In publishing component 306, the received help files enter a “publishing pipeline” that coordinates a manner and sequence in which the help files are arranged and indexed. Primary functions of publishing component 306 include building search indexes and catalogs that contain information from the authored customer assistance files. The search indexes and catalogs are together called models, which are output by publishing component 306. The models can include HyperText Mark-up Language (HTML) files and/or Microsoft Assistance Mark-up (MAML) files, or others.

Runtime component (or server runtime component in a client-server environment) 308 receives models from publishing component 306 and stores the models to form a runtime customer assistance information repository, which can be accessed to provide answers to questions received from users via client user interface 212-2. Server runtime component 308 typically responds to questions by providing a list of responses, which may be ranked, for example. In one embodiment, the responses can be output by server runtime component 308 as HTML or MAML files. Also, questions received via client user interface 204-2, responses provided to the questions, the particular response(s) that the user selects from a ranked response list, rankings that a user assigns to a response, etc., are logged by server runtime component 308. In essence, when a user connects to customer assistance system 202 (or establishes a “session”) server runtime system 308 can log information during that session until the user disconnects from system 202. In some embodiments, runtime system 308 also manages user-authorization, security, and privacy related functions of customer assistance system 202.

Analysis component 310 utilizes information logged by server runtime component 308 to analyze and determine a quality of assistance provided by system 202. Analysis component 310 aggregates the logged feedback and uses the aggregated feedback to improve the relevance of responses and general quality of assistance that system 202 provides to a user. Analysis component 310 outputs relevance and quality related information to search authoring workbench 304 and publishing component 308.

In addition to its primary sub-parts (publishing component 306, runtime component 308 and analysis component 310), data management component 208 can also include a published information download/update component (or a windows update component in a windows environment) 312, which can provide current published information from publishing component 306 to a client computer. This feature enables a client computer to download a published customer assistance model and thereby experience customer assistance even when disconnected (or offline) from online customer assistance system 202. A more detailed description of sub-components of data management component 308 is provided further below in connection with FIGS. 4 through 6.

As mentioned above, a user interacts with customer assistance 202 via customer interaction interface (or client user interface in a client-server environment) 212-2. Client user interface 212-2 includes a runtime component (or client runtime component in a client-server environment) 314, which includes a search engine (not shown separately) and other sub-components (not-shown) which can assist in monitoring user activity (such as user click-through routines when browsing through results obtained from server runtime component 308). Also, as mentioned above, a user can rank responses provided by system 202 and/or respond to specific quality-assessment related questions posed by system 202 via client user interface 314. User-formulated questions, ranks assigned by the user and other user-activity related information is provided by client runtime component 314 to server runtime component 308. In some embodiments, client runtime component 314 can download published customer assistance models via update component 312. Also, although client runtime component 314 has its own search engine, it can communicate with multiple search engines 316 and therefore a user can utilize any one of many search engines to interact with customer assistance system 202.

FIG. 4 is a block diagram illustrating sub-components of server runtime component 308 of adaptive customer assistance system 202 of FIG. 3. Server runtime component 308 includes a Web service component 402, a data interface 404, a data processing component 406 and a data store 408. Web service component 402 is configured to receive “direct” Web service requests from a client and/or to receive client requests via “gateways” such as Web sites. Component 402 arranges information included in the received requests in a standard form for utilization by data interface 404. Web service component 402 also outputs information in a form that is suitable for receipt by the clients. Component 402 includes multiple “small” executable modules that normally do not have the complete features and user interfaces of normal applications (sometimes referred to as applets) that operate in conjunction with each other to carry out the above “rendering” functions.

Data interface 404 includes a logging application program interface (API) 410, a query API 412, a query optimizer 414, a content retrieval API 416 and a content cache 418. Logging API 410 is an interface through which client logging information, such as user click-through logs and other user activity logged by client user interface 212-2, is delivered in a suitable form to a logging store in data store 408, which is described further below. Query API 412 is an interface that receives user-formulated questions, via Web service component 402, and provides the user-formulated questions in a suitable form to query optimizer 414. Query optimizer 414 arranges words and phrases in the user-formulated query in a configuration that is more amenable to faster execution by downstream components. Content retrieval API 416 and content cache 418 are included to provide relatively rapid responses to frequently asked question by bypassing the query construction components. Content retrieval API 416 helps retrieve responses to frequently asked questions from content cache 418, which stores the frequently asked questions and the corresponding responses.

Data processing component 406 includes a query builder 420 and a search engine 422. Query builder 420 receives substantially “free text” queries from query optimizer 414 and builds structured queries (such as structured SQL (Sequential Query Language) queries), which it inputs to search engine 422. Search engine 422, is general, includes any suitable module which is capable of executing the structured queries against component of data store 408.

Data store 408 includes a logging component 424 and a model data store 426, which includes a learning model 428, a free text property store 430 and an index catalog 432. Logging component 424 stores earlier-mentioned logging information such as user-formulated questions, responses provide to the questions, responses that a user selects from a ranked response list, rankings that a user assigns to a response, etc., and can provide the stored information to analysis component 310. Model data store 426 contains a runtime model provided by publishing component 306. As mentioned above, model data store 426 includes a learning model 428, a free text property store 430 and an index catalog 432. Learning model 428 includes answers, which users rated as being “good,” and questions corresponding to these answers. Index catalog 432 includes search indexes and catalogs received from publishing component 306. Free text property store 430 includes metadata for customer assistance files. Search engine 422 runs against components 428, 430 and 432 and, by carrying out comparisons with information in learning model 428, returns substantially optimum responses to user queries via data interface 404 and Web service component 402.

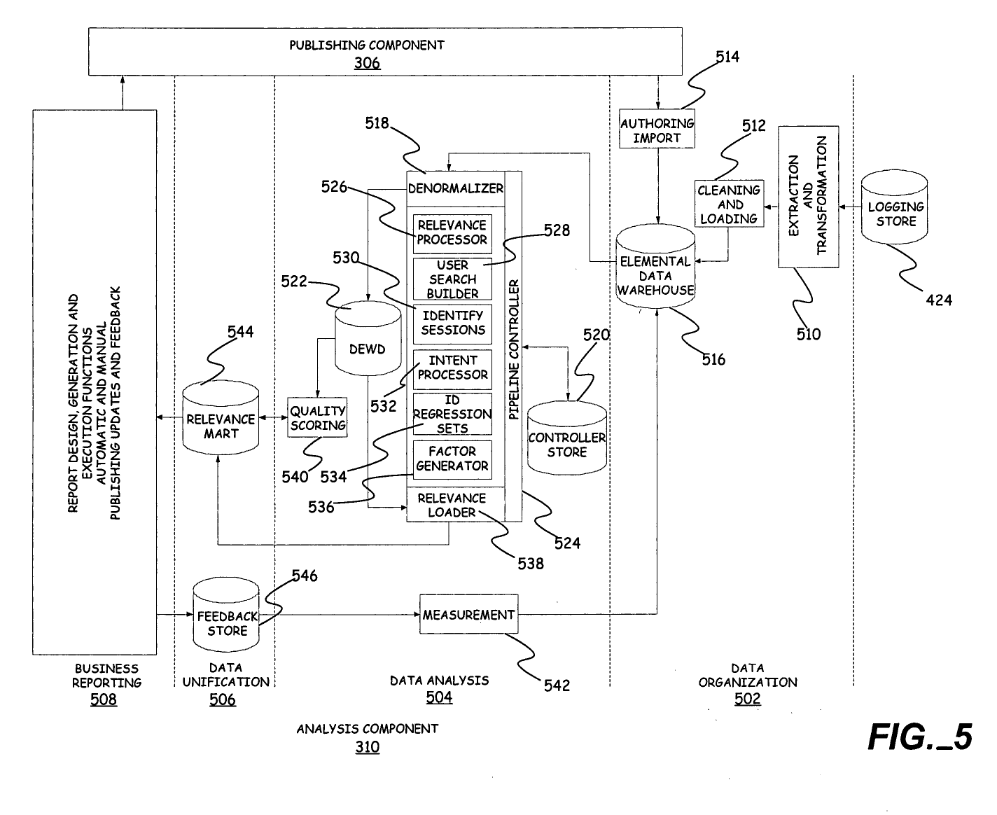

FIG. 5 is a block diagram illustrating sub-components of analysis component 310 of adaptive customer assistance system 202 of FIG. 3. Analysis component 310 includes data organization component 502, a data analysis component 504, a data unification component 506 and a business reporting component 508.

Data organization component 502 receives logged data from logging store 424 included in server runtime component 308. Logged data in logging store 424 is typically formatted by logging functions in a manner that is optimized for logging, but is usually not suitable for carrying out analysis. Data organization component 502 essentially extracts logging stream data from the logging store, transforms it into a schema that is optimized for analysis, and stores the transformed data. Sub-components of data organization component 502 include an extraction and transformation component 510, cleaning and loading component 512, an authoring import component 514 and an elemental data warehouse 516. Component 510 extracts logged data from logging store 424 and, in accordance with a predetermined schema which is optimized for analysis, separates explicit user feedback, implicit or extracted feedback, and other logged information. The extracted and transformed information is provided to cleaning and loading component 512, which carries out heuristic data checking, data validation and, in some embodiments, spam checking. Thus, component 512 improves the data that it receives and outputs data in a form that is more suitable for analysis. The extracted, transformed, and cleaned data is stored in elemental data warehouse 516, which is a data warehouse that stores a certain range of data (eighteen months, for example). Elemental data warehouse 516 is normalized to reduce the size of the data store and usually has maximum referential integrity. In order to provide better data for downstream analysis and reporting, document identification and authoring information (or metadata) is preferably added to the extracted, transformed and cleaned logging data stored in elemental data warehouse 516. Logging import 514 carries out the importing of metadata from publishing component 306 into elemental data warehouse 516.

Data analysis component 504 has a primary purpose of analyzing data stored in elemental data warehouse 516 in order to improve the relevance of answers provided to an end user. Data analysis component 504 includes a number of sub-components that operate in conjunction with each other to carry out the relevance-related analysis. The sub-components include a denormalizer 518, a controller store 520, a denormalized elemental data warehouse (DEWD) 522, a pipeline controller 524, a relevance processing component 526, a user search bundling component 528, a session identification component 530, an intent processor 532, a regression set identification (ID) component 534, a factor generator 536, a relevance loader 538, a quality scoring component 540 and a measurement component 542.

As stated above, the elemental data warehouse schema is substantially normalized. Denormalizer 518 transforms the normalized data from elemental data warehouse 516 to a denormalized form and provides the denormalized data to DEWD 522 for storage. The DEWD schema is denormalized in order to support the requirements of downstream processes.

Since a large volume of data has to be denormalized, the denormalization of new data is carried out incrementally (in batches). Controller store 520 includes batch logic that facilitates the denormalization of data in batches by denormalizer 518. These are all processes within the denormalizer that are responsible for doing their own sub-analysis in a certain manner.

In general, pipeline controller 522 manages the execution of processes in various sub-components of data analysis component 504. For example, pipeline controller 522 determines batches that are to be processed by different sub-components of data analysis component 504 and then executes those processes serially to ensure that parent processes finish before processes that are dependent are started.

Relevance processing component 526 is a classifier that groups questions and corresponding answers based on predefined degrees of relevance. User search bundling component 528 combines or “bundles” questions that are formulated differently but are substantially similar in meaning and therefore can be satisfied by a single/common response. Session identification component 530 includes logic that is capable of determining and grouping questions and corresponding answers based on different sessions that were established by users connection to customer assistance system 202. Regression set identification (ID) component 534 includes test data sets and logic that helps carry out periodic tests on relevance classifier (relevance processing component 526) to determine whether the classifier is improving over time with the ongoing addition of new classifier training sets (or factors), which are generated and stored in factor generator 536. Relevance loader 538 retrieves data from DEWD 522, converts the data into a format that allows for efficient aggregation of this data, and provides the data to a relevance mart in data unification component 506. Quality scoring component 540, in general, includes predefined metrics for quantifying a quality of assistance provided by system 202. Component 540 also includes logic to test implicitly extracted quality scores against user assigned quality scores, which helps determine whether certain analysis models need to be altered. Measurement component 542 is included to ensure that any feedback that authors may want to provide is included in the analysis process. The feedback from authors is provided by measurement component 542 to elemental data warehouse 516, where this information along with the other feedback information discussed earlier is stored.

Data unification component 506 is a repository where different processed data are unified and stored in a form that is convenient to be consumed by analysis customers. Data unification component 506 includes a relevance mart 544 and a feedback store. Relevance mart 544 aggregates data that it receives from relevance loader 538 and also aggregates quality scores that it receives from quality scoring component 540. This aggregated information is provided to business reporting component 508. Feedback store 546 stores any feedback that authors want to be included in the analysis process. This feedback is received via business reporting component 508.

Business reporting component 508 includes software that can be utilized to design, generate and execute reports that can include information retrieved from relevance mart 544 in different formats for analysis by authors, for example. Further, component 508 can include programs that update the content of publishing component 306 to thereby automatically improve the quality of assistance provided.

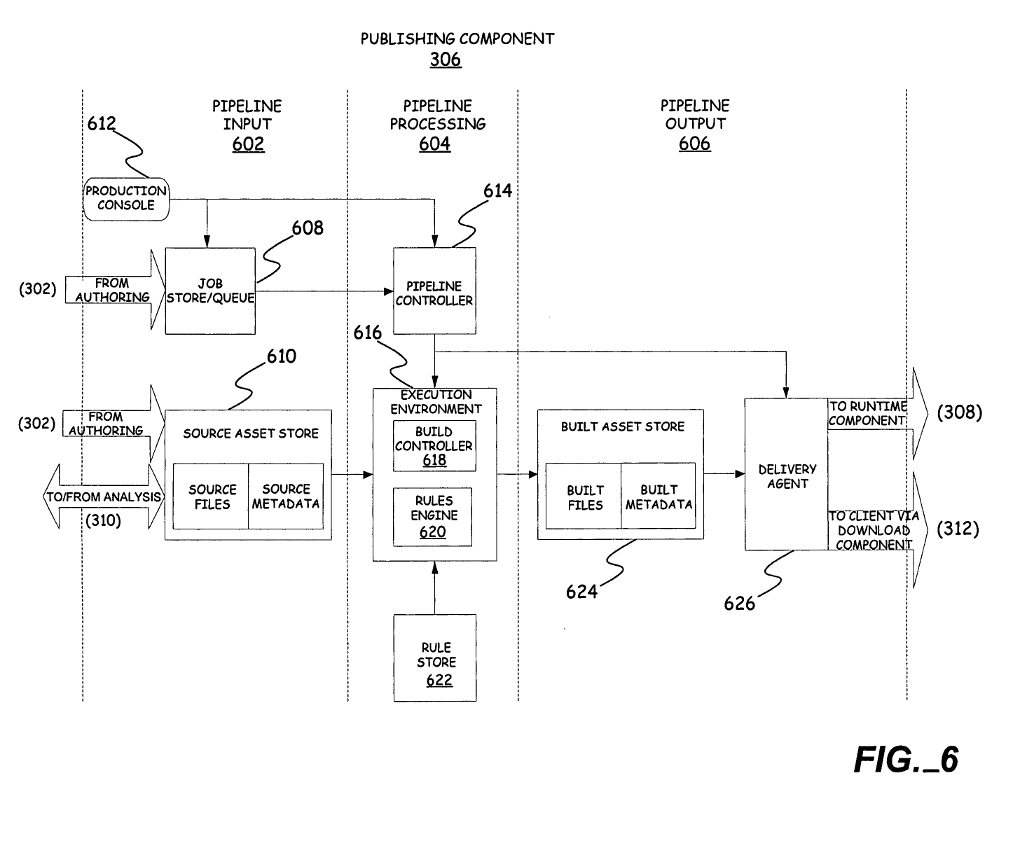

FIG. 6 is a block diagram illustrating sub-components of publishing component 306 of adaptive customer assistance system 202 of FIG. 3. Publishing component 306 includes a pipeline input 602, a pipeline processing component 604 and a pipeline output 606. Pipeline input 602 includes a job storage/queuing component 608, a source asset store 610 and a production console 612. Job storage/queuing component 608 includes logic to receive requests, related to storage/queuing of jobs, from authoring tools (such as content authoring workbench 302 (FIG. 3)). Component 608 outputs logs from running jobs and queued job requests that are ready to be dispatched. Source asset store 610, stores substantially all versions of help files that are received from content authoring workbench 302. It also ensures that unique identifiers are assigned to all versions of the help files and associated metadata with these files. Production console 612 provides a user (customer production specialist, for example) with the ability to control a configuration of job storage/queuing component 608 and a pipeline controller included in pipeline processing component 604.

Pipeline processing component 604 includes a pipeline controller 614, an execution environment 616, which includes a build controller 618 and a rules engine 620, and a rule store 622. Pipeline controller 614 dispatches queued jobs to execution environment 616 and a delivery agent, which is a part of pipeline output 606. It performs load balancing and can perform logging and security functions. Build controller 618 governs execution of jobs within an execution environment 616 and facilitates load balancing. Rules engine 620 applies rules to meet job requirements by transforming or rendering source assets (help files) into built assets (search indexes and catalogs). Rule store 622 is a common storage component of pipeline transformation configuration information and components (also known as “rules”) governing transformation of source assets into built assets.

Pipeline output 606 includes a built asset store 624 and a delivery agent 626. Built asset store 624 stores all produced (transformed, rendered) assets (built assets) that are received from execution environment 616. It also ensures that unique identifiers are assigned to all built assets or files, and associates built metadata with these files. Delivery agent 626 includes logic that carries out a synchronized staged transfer of Built Assets to server runtime component 308. The built assets are also provided to download component 312, from which a client computer can download help information.

It should be noted that the components and sub-component of customer assistance system 202 are designed in a manner that allows for separate development of the individual components and subsequent plugging-in of these components to form system 202. In other words, system 202 is designed as a “plugglable” framework.

Customer assistance system 202 of the present invention essentially directly connects a user of an application to the application and the application developer. The continuous feedback mechanism helps ensure that the more a user interacts with customer assistance system 202, the better it gets.

In summary, providing customer assistance in accordance with embodiments of the present invention involves creating help content, publishing help files to online servers, and preparing help files to be downloaded to client machines. The client machines, when connected, interact with their online servers. Through this interaction, feedback is gathered and used to improve the relevance of the user interaction thereby impacting both search and browse and aiding in the construction of better help documentation. Through the feedback, new relevance models and new content are generated. The new models and content are then made available to the online systems, and client download systems, through the publishing system. This loop is continuous and therefore customer assistance improves with time.

Although the present invention has been described with reference to particular embodiments, workers skilled in the art will recognize that changes may be made in form and detail without departing from the spirit and scope of the invention.

What is claimed is:

1. A customer assistance system comprising:
a customer-interaction interface; and
a data management component comprising:
a runtime component, which includes a customer assistance model, configured to receive a user-formulated question from the customer-interaction interface, and to provide an answer to the user-formulated question, based on information included in the customer assistance model, via the customer-interaction interface; and
an analysis component configured to automatically analyze the user-formulated question and the corresponding answer, and to provide an analysis output for use in improving a quality of customer assistance.

2. The customer assistance system of claim 1 wherein the data management component further comprises a publishing component that is configured to receive authored customer assistance files and to form the customer assistance model based on the received authored customer assistance files, and wherein the publishing component is further configured to provide the customer assistance model to the runtime component.

3. The customer assistance system of claim 2 wherein the customer assistance model comprises search indexes and catalogs that contain information from the authored customer assistance files.

4. The customer assistance system of claim 2 and further comprising a customer data creation interface for authoring the customer assistance files.

5. The customer assistance system of claim 1 wherein the runtime component comprises a logging component that stores the user-formulated question, the corresponding answer and information related to a degree of user-satisfaction with the answer.

6. The customer assistance system of claim 5 wherein the analyses component carries out the automatic analysis by retrieving, from the logging component, the user-formulated question, the corresponding answer and information related to a degree of user-satisfaction and analyzing the retrieved user-formulated question, the answer and the information related to the degree of user-satisfaction with the answer.

7. The customer assistance system of claim 1 wherein the analysis output is based on a user-assigned quality score for the answer provided for the user-formulated question.

8. The customer assistance system of claim 1 wherein the analysis output is based on an implicitly extracted quality score for the answer provided for the user-formulated question.

9. The customer assistance system of claim 1 wherein the analysis output is based on a user assigned quality score, and an implicitly extracted quality score, for the answer provided for the user-formulated question.

10. The customer assistance system of claim 1 wherein the analysis output is utilized by the publishing component to update the customer assistance model.

11. The customer assistance system of claim 2 wherein the analysis output is utilized by authors as a guideline for creating new customer assistance files.

12. The customer assistance system of claim 1 wherein the analysis component is further configured to detect holes that define missing customer assistance information.

13. A computer-implemented software system employing the customer assistance system of claim 1 as a common customer assistance platform for a suite of software products.

14. The customer assistance system of claim 1 wherein the analysis component is configured to automatically analyze, in substantially real-time, the user-formulated question and the corresponding answer.

15. A computer-implemented method for providing customer assistance for software products, comprising:
receiving a user-formulated question;
providing, based on information included in a customer assistance model, an answer to the user-formulated question;
analyzing, in substantially real-time, the user-formulated question and the corresponding answer; and
providing an analysis output for use in improving a quality of customer assistance.

16. The method of claim 15 and further comprising forming the customer assistance model from authored customer assistance files.

17. The method of claim 16 wherein the customer assistance model comprises search indexes and catalogs that contain information from the authored customer assistance files.

18. The method of claim 15 wherein the analysis output is based on a user-assigned quality score for the answer provided for the user-formulated question.

19. The method of claim 15 wherein the analysis output is based on an implicitly extracted quality score for the answer provided for the user-formulated question.

20. The method of claim 15 wherein the analysis output is utilized to update the customer assistance model.
